(19) United States
(12) Patent Application Publication
(10) Pub. No.: US 2007/0272644 A1
(43) Pub. Date: Nov. 29, 2007

(54) Heavy lift trailer crane

(76) Inventor: Alan Rodrick McDonald, Meaford (CA)

Correspondence Address: D.W. EGGINS, 18 DOWNSVIEW DRIVE, BARRIE, ON, L4M 4P8, US

(21) Appl. No.: 11/440,134

(22) Filed: May 25, 2006

(51) Int. Cl. B66C 23/84

(52) U.S. Cl. 212/245

(57) ABSTRACT

A heavy lift crane is mounted on a trailer for towing by a highway tractor; with a hydraulic pump and its driving motor mounted for rotation with the crane, with direct connection to the crane primary systems, enabling unimpeded slewing. The crane outriggers are powered by an auxiliary motor and pump, located on the trailer, with outrigger controls operable from ground level. An additional pair of outriggers enable safe use of the crane to position individual outrigger support pads. Access stairs and catwalks give the operator safer access. The construction format leads to lower cost structures with enhanced serviceability and safety.

### CROSS-REFERENCE TO RELATED APPLICATIONS

Not Applicable (N/A)

### STATEMENT REGARDING FEDERALLY SPONSORED RESEARCH OR DEVELOPMENT

N/A

### REFERENCE TO A SEQUENCE LISTING, A TABLE, OR A COMPUTER PROGRAM LISTING

N/A

### COMPACT DISC APPENDIX

N/A

### BACKGROUND OF THE INVENTION

1. The present invention is directed to a trailer-mounted heavy lift crane system, for use with a highway tractor as the towing vehicle.

2. While trailer-mounted cranes are known in the art, no attempt appears to have been made to extend such use to heavy-lift cranes.

Truck-mounted heavy-lift cranes are common-place, and suffer from a number of serious disadvantages. Such heavy-lift truck cranes are generally operated by a single individual, who is required in most jurisdictions to be a qualified and licensed crane operator.

Owing to the vehicular characteristics, these units are exceedingly tiresome to drive, and are quite unsuited for traveling at highway speeds or for long distances.

Due to the circumstances in which the units have evolved, the truck motor is used to power the crane and its sub-systems, such as the main elevating ram, the traverse, and the hydraulic-powered outriggers that stabilize the unit. This has resulted in an unecononic utilization of a large haulage motor driving a hydraulic pump that requires considerably less power than that available from the motor. The utilization of the truck motor as the pump power source requires the transfer of hydraulic power to the rotatable crane base, which is mounted upon a ring-gear.

Also, at least some of the instrumentation of the truck engine requires read-outs for reference use by the operator when at the crane controls, which involves further complexity.

Use of the powerful truck motor for long periods of time, running in an underloaded or unloaded condition is inefficient, uneconomic and environmentally reprehensible.

So far as safety and ergonomics are concerned, the driver/operator normally drives the vehicle to the job site. Having parked the vehicle for deployment of the crane, he then extends the outriggers, and descends from the tuck cab to place footpads beneath the outriggers. This may involve mounting to the crane cab, itself a challenging and potentially dangerous feat, and there utilizing the crane to maneuver the pads into location. He then descends from the crane cab to lock the outriggers in place, and then returns to his crane controls to commence the business of lifting a load.

Upon completion of his lifting/lowering operation, the driver/operator then has to do things in reverse sequence in order to ready the truck for the road.

It should be added that the undue length required of a truck to accommodate a moderately long crane boom imposes serious limits on the extent to which the truck can be jacked in order to be leveled upon an uneven site. Furthermore, it can readily cause the front of the vehicle to be raised so high as to render the motor compartment virtually inaccessible.

The prior art truck-cranes are also quite unsuitable for safely and conveniently carrying out the required daily inspections of the boom and maintenance, including accessing the jib pins.

### BRIEF SUMMARY OF THE INVENTION

The present invention provides a heavy lift crane mounted upon a trailer chassis, for use in combination with a road tractor, as a tractor-tailer combination.

In a preferred embodiment, the hydraulic pump and its driving motor is mounted upon the rotatable crane base, for rotation with the crane, thereby enabling minimalised direct connection of the primary hydraulic systems of the crane (i.e. slewing motor and boom rams) to the hydraulic pump.

The powering of the stabilizing crane outriggers is preferably provided by an auxiliary motor and its pump, located on the body of the trailer, and preferably having outrigger controls that are operable from ground level.

The traditional four outriggers are supplemented by an additional pair, thus enabling the stabilized use of the crane in positioning outrigger support pads or footings for all of the outriggers.

Safe access from ground level to the floor of the trailer and to the crane cab is provided by way of embedded stairs and retractable catwalks, respectively.

The present invention thus provides a trailer-mounted heavy-lift crane having an extended trailer with fifth wheel hitch means at the front end, and a plurality of road wheels at the rear end of the trailer; turntable means located at the trailer rear end, having an operator's cab mounted thereon; a crane boom pivotally mounted on the turntable means for upward and downward pivotal displacement; hydraulic ram means for elevating and lowering the boom; hydraulic slewing means for rotatably slewing the turntable means; hydraulic pump means mounted on the turntable means, for slewing displacement therewith; and prime-mover means secured in driving relation with the hydraulic pump means, in use to power the hydraulic ram and the hydraulic slewing means, whereby the turntable means is substantially unrestricted in the extent of its rotatable slewing.

The aforesaid prime mover is most usually an internal combustion motor. However in some working environments the use of an electric motor may prove to be feasible.

The location of an internal combustion motor upon the turntable, adjacent the operators cab serves as a convenient local source of hot water for heating that cab, and as a simple and convenient power source for an air-conditioning system for the cab.

A plurality of laterally extensible, laterally paired outrigger jacking means are located in mutually spaced relation along the trailer, to stabilize the crane against overturning moments generated by loads applied to the load boom. The provision of three such jacking pairs enables use of the crane for positioning a support pad beneath each of the outriggers.
An auxiliary hydraulic pumping system, operable independently of the prime mover, may be connected in selectively controllable driving relation with the outrigger jacking means. Built-in step means may be provided to facilitate safe access to the trailer deck and the operator's cab.

### Access to the crane cab may include retractable catwalk means mounted on the crane deck to facilitate safe access by the crane operator to his cab.

The mounting of a crane with its associated ring gear and swing bearing upon a trailer chassis, absent the former drive shaft and differential of a truck, and with judicious location of the trailer running gear, enables the convenient assembly/disassembly/reassembly of the ring gear and swing bearing by the relatively simple expedient of jacking up the crane and dropping the ring gear and/or swing bearing down, for lateral removal beneath the crane chassis.

The presented format of a tractor and a trailer-mounted crane enables the adoption of a 55 to 60 foot base boom.

The separation of the transport function from the crane functions, by the provision of a tractor, serves also to provide transportation for the operator without requiring the involvement of the crane, as the tractor can conveniently serve as personal transportation for the operator, to and from the work-site.

The elongated deck associated with the adopted trailer format also provides valuable space to accommodate associated boxes of required tools, such as rigging tools and spreader bar, and a personnel basket. The extensive under-deck space is very well suited to the bulk storage of gaseous and/or liquid fuels.

### BRIEF DESCRIPTION OF THE SEVERAL VIEWS OF THE DRAWING

Certain embodiments of the present invention are described for purposes of illustration, it being understood that other embodiments may readily occur to one skilled in the art, having reference to the foregoing, and the invention is not limited hereto other than as set forth in the accompanying claims, reference now being made to the accompanying drawings, wherein:

FIG. 1 is a side elevation of a heavy lift crane mounted upon a trailer, in accordance with the present invention, and hitched to a highway tractor;

FIG. 2 is a like view of another embodiment with an extended boom; and,

FIG. 3 is a plan view of the FIG. 1 embodiment.

### DETAILED DESCRIPTION OF THE INVENTION

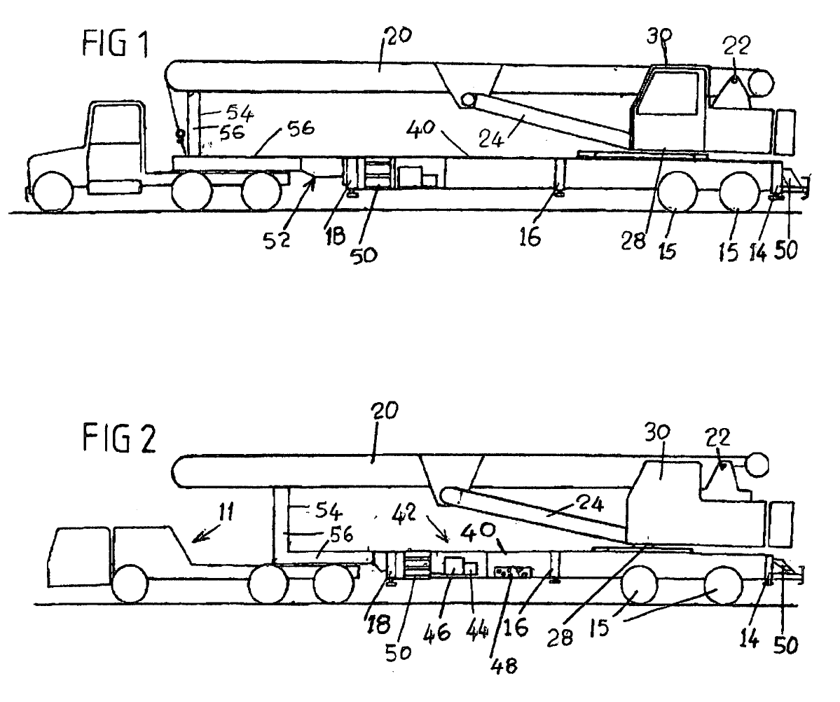

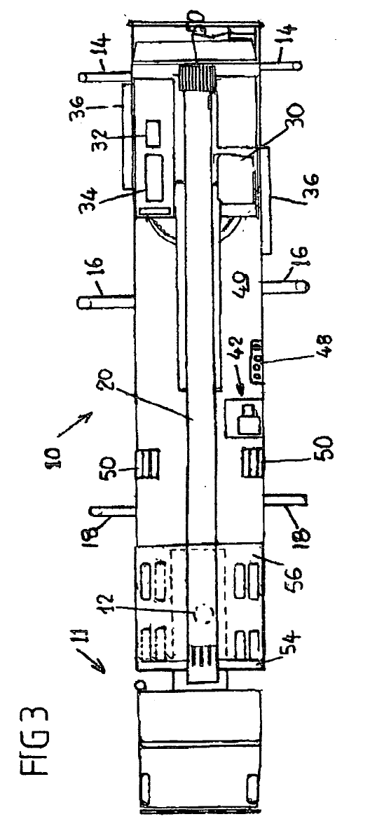

Referring to FIGS. 1 and 3, a heavy-lift trailer-crane 10 is shown, hitched to a highway tractor 11 by way of a fifth wheel 12 (shown in phantom, see FIG. 3).

The crane 10 is illustrated as having two pairs of trailer wheels 15 arranged in tandem at the rear of the crane 10. The location of the trailer wheels, and their type of suspension is influenced by the need to provide clear access beneath the ring gear and swing bearing, to enable ring gear and swing bearing removal/servicing/replacement by the relatively simple expedient of jacking up the crane and dropping the ring gear and/or swing bearing vertically down, for lateral removal beneath the crane chassis, as referred to above. The adoption of an upwardly tapered ring gear housing can then be utilized to provide self-centering location of the ring gear, on reinstallation.

The crane 10 has the usual two pairs of stabilizing outriggers 14, 16, and a further third pair of outriggers 18, located adjacent the front of the crane 10.

The crane 10 has a boom 20, pivoted at 22, and elevated and lowered by a pair of hydraulic rams 24. The boom 20, together with rams 24 and pivot 22 are mounted on turntable 28, together with the operators cab 30. Mounted upon turntable 28, beside the cab 30, is a hydraulic pump 32 and its prime mover 34 (see FIG. 3), shown in the form of an internal combustion engine. This power unit provides high pressure hydraulic fluid to power the rams 24, the winches, and the slewing gear (not shown), which slews the turntable 28, and with it the boom 20, rams 24, cab 30, pump 32 and prime mover 34.

### A pair of retractable cat-walks 36 are located adjacent the cab 30, to facilitate access.

Forward of the cab is a work-deck 40, which contains an auxiliary hydraulic system 42 to power the outriggers 14, 16, 18. The auxiliary system 42 consists of a hydraulic pump 44 driven by motor 46. The respective controls 48 for the six outriggers, 14, 14; 16, 16; and 18, 18 are located at the side of the crane 10, so as to be accessible at ground level.

Access to the deck 40 is provided by a pair of access steps 50, which can be built-into the sides of the trailer, and another set 50 located at the rear of the trailer, positioned over an extended rear fender.

The frame/chassis 52 of the crane trailer includes a front bridge 54, upon which the boom 20 is stowed during transport. This bridge 54, and the adjacent forward portion of deck 40 houses a counterweight mass 56 (generally of concrete), to at least partially balance the mass of the crane per se, when in its operative mode, and to compensate at least in-part for the former mass of the truck front portion, with its wheels, motor and transmission.

The FIG. 2 embodiment comprises substantially the same elements as FIG. 1, but with an extended boom, and an appropriately customized and proportioned tractor. The provision of a base boom as long as 55 to 60 feet is contemplated.

1. A trailer-mounted heavy-lift crane having an extended trailer with fifth wheel hitch means at the front end, and a plurality of road wheels at the rear end of the trailer; turntable means located at said trailer rear end, having an operator's cab mounted thereon; a crane boom pivotally secured to said turntable means for upward and downward pivotal displacement; hydraulic ram means for elevating and lowering said boom; hydraulic slewing means for rotatably slewing said turntable means; hydraulic pump means mounted on said turntable means, for slewing displacement therewith; and prime-mover means secured in driving relation with said hydraulic pump means, in use to power said hydraulic ram and said hydraulic slewing means, whereby said turntable means is substantially unrestricted in the extent of said rotatable slewing.

2. The heavy lift crane as set forth in claim 1, wherein said prime mover is an internal combustion motor.

3. The heavy lift crane as set forth in claim 1, having a plurality of laterally extensible outrigger jacking means located in mutually spaced relation along said trailer, to stabilize said crane against overturning moments generated by loads applied to said load boom.

4. The heavy lift crane as set forth in claim 1, said outrigger jacking means consisting of three retractable, hydraulically actuated extensible jacks located in mutually spaced apart relation along each side of said trailer.

5. The heavy lift crane as set forth in claim 3, including an auxiliary hydraulic pumping system operable independently of said prime mover, and connected in selectively controllable driving relation with said outrigger jacking means.

6. The heavy lift crane as set forth in claim 4, including an auxiliary hydraulic pumping system operable independently of said prime mover, and connected in selectively controllable driving relation with individual ones of said outrigger jacking means.

7. The heavy lift crane as set forth in claim 1, including stair means to facilitate access to said crane.

8. The heavy lift crane as set forth in claim 7, wherein said stair means are built into at least one side of said trailer.

9. The heavy lift crane as set forth in claim 7, wherein said stair means are located at the rear of said trailer, positioned over an extended rear fender portion.

10. The heavy lift crane as set forth in claim 7, including catwalk means mounted on said crane deck to facilitate access to said operator's cab.

11. The heavy lift crane as set forth in claim 9, wherein said catwalk means are retractably mounted on said crane deck, adjacent said cab.

12. The heavy lift crane as set forth in claim 1, having an extensive substantially unobstructed deck area to receive associated tools in stored relation thereon.

12. The heavy lift crane as set forth in claim 1, including built-in ballast means integrated with structural front portions of said trailer.
